(19) United States
(12) Patent Application Publication
(10) Pub. No.: US 2026/0320801 A1
(43) Pub. Date: Oct. 15, 2026

(54) ENHANCING SHADOW GENERATION USING SHADOW SUPPRESSION

(71) Applicant: Capital One Services, LLC, McLean, VA (US)

(72) Inventors: Deepak RAMAMOHAN, Mysuru (IN); Aakarshika SINGH, Secunderabad (IN)

(73) Assignee: Capital One Services, LLC, McLean, VA (US)

(21) Appl. No.: 19/177,686

(22) Filed: Apr. 14, 2025

(51) Int. Cl. G06T 7/11; G06T 5/20; G06T 5/70; G06T 7/64

(52) U.S. Cl. CPC G06T 7/11; G06T 5/20; G06T 5/70; G06T 7/64; G06T 2207/30248

(57) ABSTRACT

Disclosed herein are system, method, and computer program product embodiments for improving image suppression techniques within image processing. A system generates a convex hull of an image segmentation mask within an image. The image segmentation mask depicts the shape of an object within the image, and the image includes one or more pixels each having a corresponding value. The system updates a size of the image segmentation mask to match a size of the convex hull. The system dilates a portion of the image segmentation mask using a kernel. The system applies a blur filter to the image segmentation mask. The system inverts a pixel value of a target region within the image, alters the target region by multiplying the target region with the image segmentation mask, and inverts the pixel value of the target region within the image.

### BACKGROUND

### Field

This field is generally related to improving image processing via shadow suppression within images.

### Related Art

Digital platforms such as social media websites or e-commerce websites often host images from different sources. For example, an e-commerce website may allow different merchants to upload product information and execute transactions on the e-commerce website. Similarly, unrelated users may post content such as text, images, and video on a social media site. While the host platform displays the uploaded content (e.g., text, images, video), the host platform often has little control over the specification of the uploaded content. For example, the host platform may have little control over the size of files (e.g., photos, videos) that are uploaded. As a result, unnecessarily large files may be uploaded by users. These files may degrade network and operational performance at the host platform because of the computing resources needed to manipulate such large files. Similarly, by hosting content from different sources, the host platform may appear visually disorganized.

### BRIEF SUMMARY

Disclosed herein are system, apparatus, device, method and/or computer program product embodiments, and/or combinations and sub-combinations thereof, for improving image processing by using a shadow suppression technique to reduce or remove a shadow within an electronic image. This disclosure describes a system that receives the segmentation mask of an image within the image. The system generates a convex hull of the segmentation mask, then dilates and blurs the segmentation mask. The system further combines the segmentation mask with a region of the image including a shadow to suppress the depicted shadow. By suppressing the shadow within the image: (1) the size of the image may be reduced to improve computing resource utilization; and (2) images from disparate sources appear more uniform.

### BRIEF DESCRIPTION OF THE DRAWINGS

The accompanying drawings are incorporated herein and form a part of the specification.

FIG. 1 depicts a block diagram of an environment, according to some embodiments.

FIG. 2 depicts an image segmentation mask, according to some embodiments.

FIG. 3 depicts a convex hull of an image segmentation mask, according to some embodiments.

FIG. 4 depicts a dilated image segmentation mask, according to some embodiments.

FIG. 5 depicts a blurred image segmentation mask, according to some embodiments.

FIG. 6 depicts a target region of an image, according to some embodiments.

FIG. 7 depicts combining an image segmentation mask and target region of an image, according to some embodiments.

FIG. 8 depicts a target region of an image, according to some embodiments.

FIG. 9 depicts a flowchart illustrating a method for suppressing a shadow in an image, according to some embodiments.

FIG. 10 depicts a flowchart illustrating a method for dilating an image, according to some embodiments.

FIG. 11 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for improving image processing via shadow suppression.

Internet platforms such as social media websites or e-commerce websites may host content from third parties. For example, users of the social media website may upload content including text, photos, videos, or any combination thereof, to the platform. Similarly, an e-commerce website may allow merchants to upload content including products or services for sale. By hosting third party content, the platform has to accommodate the format (e.g., PNG file, JPEG file) and size (e.g., 1920x1080 resolution, 3840x2160 resolution) of the content. However, based on the computing resources at the host platform servers and the size of the uploaded content, performance at the host platform may be degraded. Hosting and allowing user interaction with a 4K resolution image may consume more CPU and memory (e.g., RAM) at a server of the host platform than a lower resolution image. Oftentimes, uploaded images or video may include content that can be removed or cropped to reduce the overall size of the content. Similarly, hosting content from third parties may result in the website of the host platform appearing disjointed. Manually editing these images to impose uniformity is time consuming. Current systems may also attempt to automatically edit images. However, these automated systems are often sensitive based on how the image was taken (e.g., lighting, angle, resolution). Furthermore, these automated systems may introduce artifacts that make the resulting image appear unnatural or unrealistic. For example, an automated system may alter an image of an object to add or edit a shadow of the object in an attempt to make it appear more realistic. However, the shadow in the image may: (1) increase the overall size of the image thereby needlessly consuming computing resources; and (2) appear unrealistic.

To address such issues, systems and methods are disclosed that automatically perform shadow suppression within images. For example, the system may receive an image of an object and an image segmentation mask of the object. The image may be grayscale, such that each pixel has a value between 0 and 255. In some embodiments, the image may be depicted in color such as red-green-blue, where each pixel has a red value, a green value, and a blue value. The image may include a shadow of the object. In some embodiments, the shadow may be the original shadow captured when the image is taken. In some embodiments, the shadow may have been added or edited after the image was taken. The image segmentation mask may be an altered version of the image where the object is highlighted. For example, the image segmentation mask may depict the object in a first color (e.g., white) and the remainder of the image may be a second color (e.g., black).

The system may then: (1) generate a convex hull of the image segmentation mask; (2) resize the segmentation mask based on the convex hull; (3) dilate the image segmentation mask to increase its size; (4) apply a blur filter to the image segmentation mask; and (5) combine the image with the segmentation mask to reduce the size of the shadow in the image. By reducing the size of the shadow in the image, the overall size of the image may be reduced. This reduces the amount of computing and networking resources utilized when the image is accessed, moved, viewed, etc. Furthermore, this process makes the image appear more realistic. As a result, the platform hosting the image will have a more uniform look and feel. Thus, although images on the platform may have been captured by disparate third parties, they will appear more uniform on the host platform.

Various embodiments of these features will now be discussed with respect to the corresponding figures.

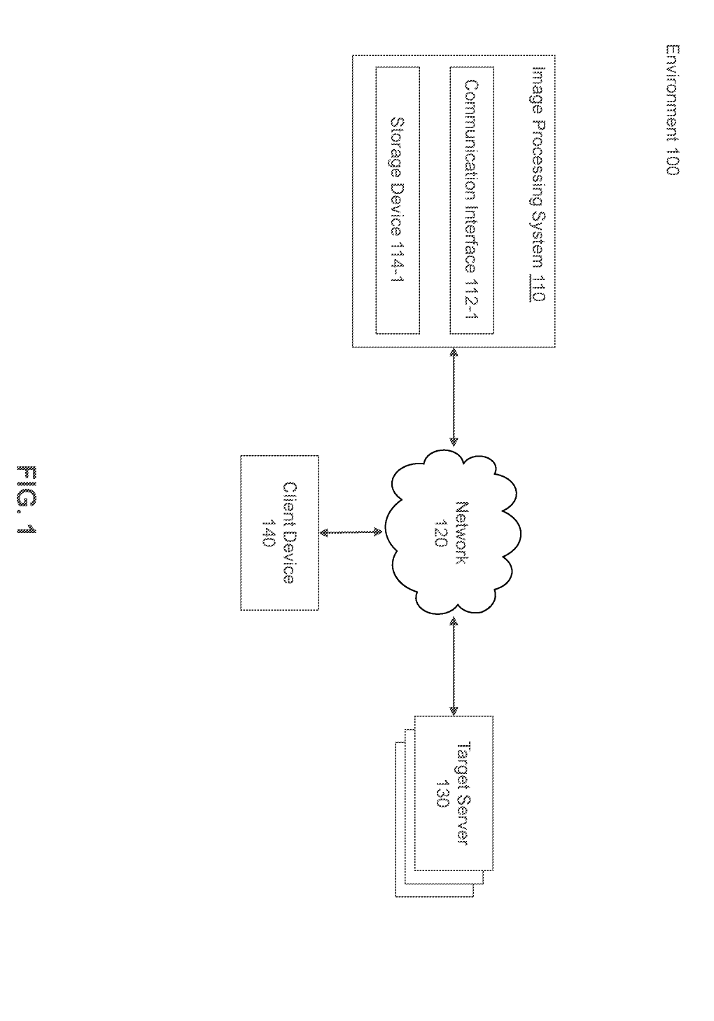

FIG. 1 depicts a block diagram of environment 100. Environment 100 includes image processing system 110, network 120, target server 130, and client device 140.

Image processing system 110 may be any device configured to receive an image and suppress a shadow depicted within the image. For example, image processing system 110 may receive an image of a vehicle for posting to an e-commerce website. Image processing system 110 may alter and/or remove a shadow depicted within the image, prior to the image being displayed at the e-commerce website. Similarly, image processing system 110 may receive an image for posting to a social media site and alter and/or remove a shadow depicted in the image.

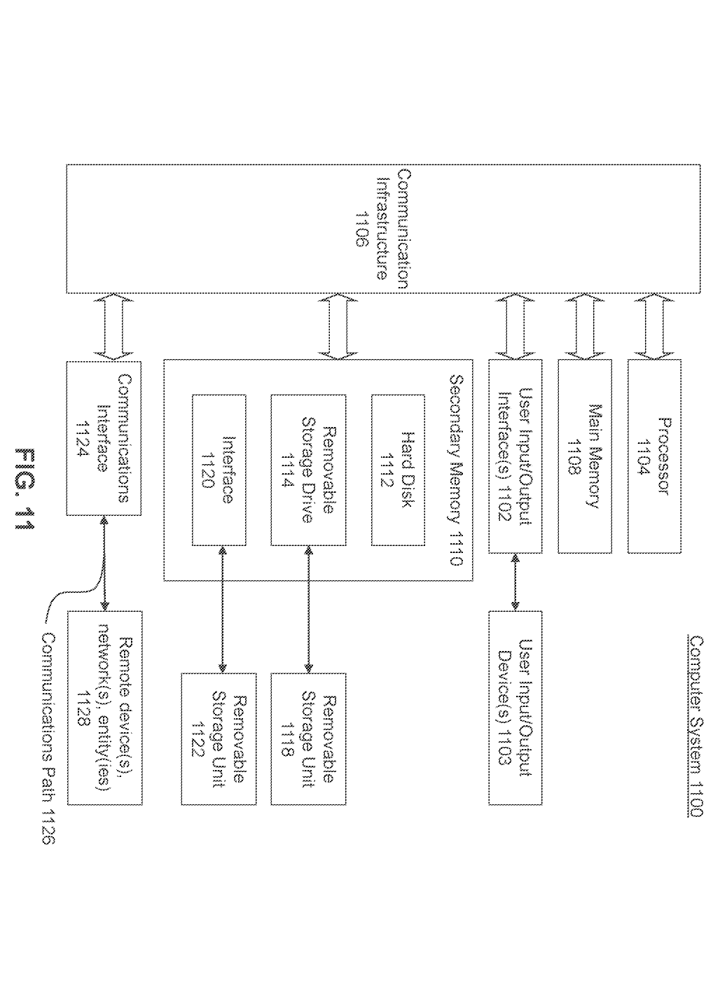

Image processing system 110 may be implemented using a computing device such as a desktop workstation, laptop or notebook computer, netbook, tablet, smart phone, and/or other computing device. In some embodiments, image processing system 110 may be implemented as an application in an enterprise computing system and/or a cloud-computing system. In some embodiments, image processing system 110 may be a computer system such as computer system 1100 described with reference to FIG. 11. In some embodiments, image processing system 110 may host the processed image for display. For example, image processing system 110 may utilize one or more servers to host an e-commerce website displaying the altered images.

Image processing system 110 includes storage device 112-1 and communication device 114-1. Storage device 112-1 may be any memory storage device. Image processing system 110 may use storage device 112-1 to store data such as received images. Communication device 114-1 may comprise any suitable network interface capable of transmitting and receiving data, such as, for example a modem, an Ethernet card, a communications port, or the like. Communications device 114-1 may be able to transmit data using any wireless transmission standard such as, for example, Wi-Fi, Bluetooth, cellular, or any other suitable wireless transmission. Image processing system 110 may use communication device 114-1 to communicate with entities on network 120. For example, image processing system 110 may use communication device 114-1 to receive images from client device 140. Similarly, image processing system 110 may transmit images to target server 130 via network 120.

As noted above, image processing system 110 may receive an image. In some embodiments, image processing system 110 may perform a shadow detection process to determine whether the image has a shadow, and if so, whether the shadow needs to be suppressed. For example, image processing system 110 may be configured to detect a region of the image depicting a shadow, and generate a polygon (e.g., bounding box) defining the region of the shadow. In some embodiments, image processing system 110 may determine whether the shadow needs to be suppressed based on a proportion of the image that depicts the shadow. For example, image processing system 110 may determine that a shadow in the image should be suppressed when the shadow is depicted in at least 30% of pixels of the image.

As will be discussed below, image processing system 110 may use an image segmentation mask to suppress the shadow of an image. The image segmentation mask may be a representation of an object within the image, such that the object is one pixel color (e.g., white) and the remainder of the image is a second pixel color (e.g., black). In some embodiments, image processing system 110 may receive the image segmentation mask along with the image. In some embodiments, image processing system 110 may generate the image segmentation mask using an objection detection filter.

Network 120 may be any type of computer or telecommunications network capable of communicating data, for example, a local area network, a wide-area network (e.g., the Internet), or any combination thereof. The network may include wired and/or wireless segments.

Target server 130 may be a computing device configured to store images. In some embodiments, target server 130 may provide one or more images to image processing system 110 for shadow suppression. In some embodiments, target server 130 may receive images from image processing system 110 with suppressed shadows. Target server 130 may be implemented using a computing device such as a desktop workstation, laptop or notebook computer, netbook, tablet, smart phone, and/or other computing device. In some embodiments, target server 130 may be implemented as an application in an enterprise computing system and/or a cloud-computing system. In some embodiments, target server 130 may be a computer system such as computer system 1100 described with reference to FIG. 11. Although target server 130 and image processing system 110 are depicted as separate entities, in some embodiments, target server 110 may include image processing system 110, or vice versa. For example, target server 130 may host a social media website and include image processing system 110 to alter images uploaded by users of the social media website.

Client device 140 may be any device configured to interact with image processing system 110 and target server 130. For example, client device 140 may store one or more images to be uploaded to target server 130. Client device 140 may send the one or more images to target server 130, and target server 130 may forward the one or more images to image processing system 110 for shadow suppression. In some embodiments, client device 140 may send the one or more images to image processing system 110. Image processing system 110 may suppress shadows within the one or more images and return the updated one or more images to client device 140. In some embodiments, image processing system 110 may directly send the updated images to target server 130.

Client device 140 may be implemented using a computing device such as a desktop workstation, laptop or notebook computer, netbook, tablet, smart phone, and/or other computing device. In some embodiments, client device 140 may be implemented as an application in an enterprise computing system and/or a cloud-computing system. In some embodiments, client device 140 may be a computer system such as computer system 1100 described with reference to FIG. 11.

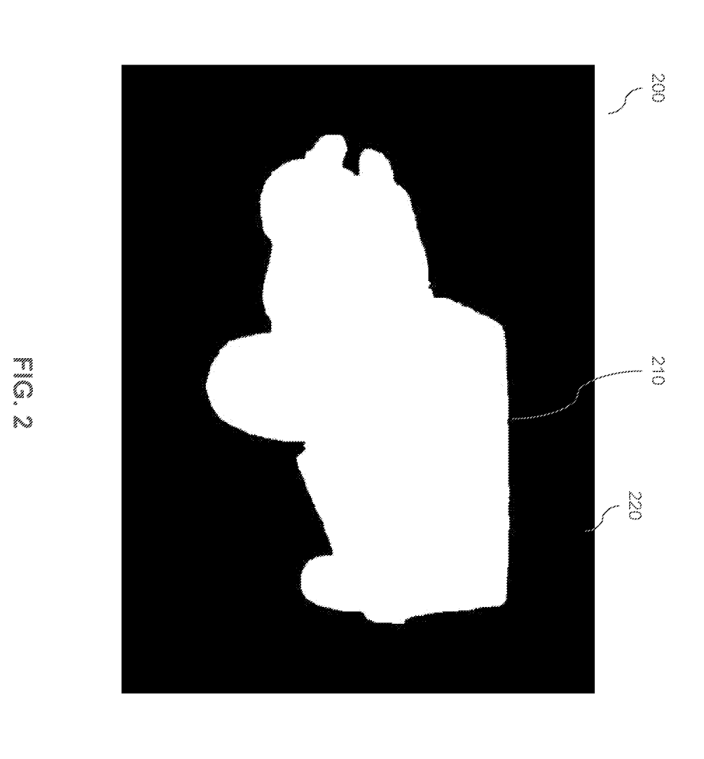

FIG. 2 depicts image segmentation mask 200, according to some embodiments. Image segmentation mask 200 may depict an object within an image. For example, the object of image segmentation mask 200 may be depicted in a first pixel color (e.g., white, 0). A remaining area (e.g., the background) of image segmentation mask 200 may be depicted in a second pixel color (e.g., black, 255). For example, the image may depict an object, e.g., a vehicle. It should be understood by those of ordinary skill in the art that a vehicle is merely one example of an object that may be depicted in the image, and that other objects may be depicted in accordance with aspects of the present disclosure. As a result, image segmentation mask 200 may show an outline of the object depicted in the image drawn using white pixels. Image segmentation mask 210 may include object region 210 and background region 220. Object region 210 may depict the object in the image (e.g., the vehicle). Background region 220 may include the remainder of the image. In some embodiments, image processing system 110 may generate image segmentation mask 200 from an image. In some embodiments, image processing system 110 may receive image segmentation mask 200 from, for example, target server 130 or client device 140.

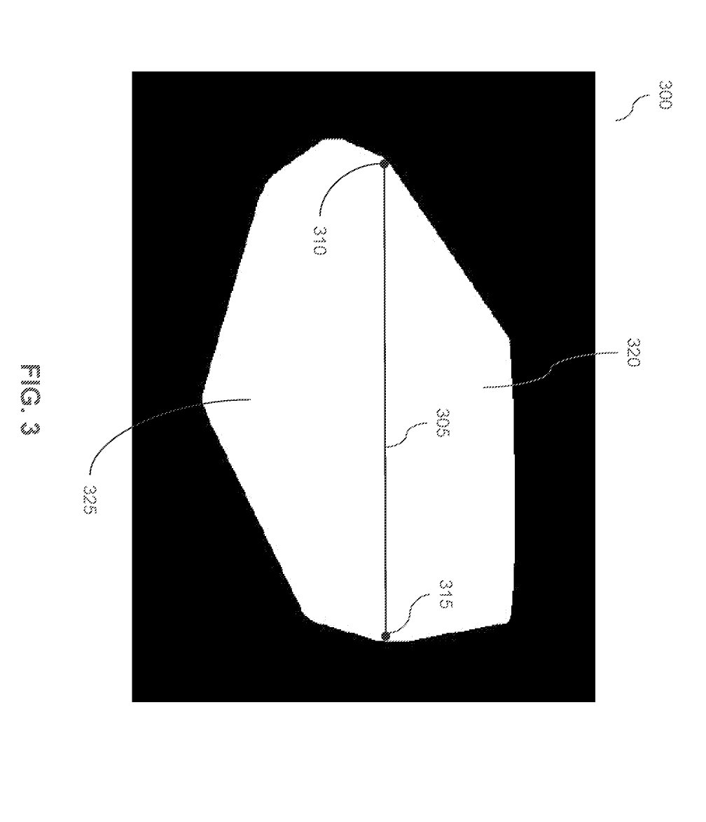

FIG. 3 depicts convex hull 300 of an image segmentation mask 200, according to some embodiments. Image processing system 110 may generate convex hull 300 of image segmentation mask 200. Convex hull 300 may be a polygon such that any two points on the object depicted in the image are within the region of convex hull 300. As noted above image segmentation mask 200 may be of a vehicle within an image. Convex hull 300 may be generated such that it includes a line drawn between any two points on the vehicle. For example, as shown in FIG. 3, a line 305 may be drawn between points 310 and 315 to create an upper half (or region) 320 and a lower half (or region) 325. It should be understood by those of ordinary skill in the art that this is merely one example, and that the line 305 may be drawn to create other sections as well, e.g., a left half (or region) and a right half (or region).

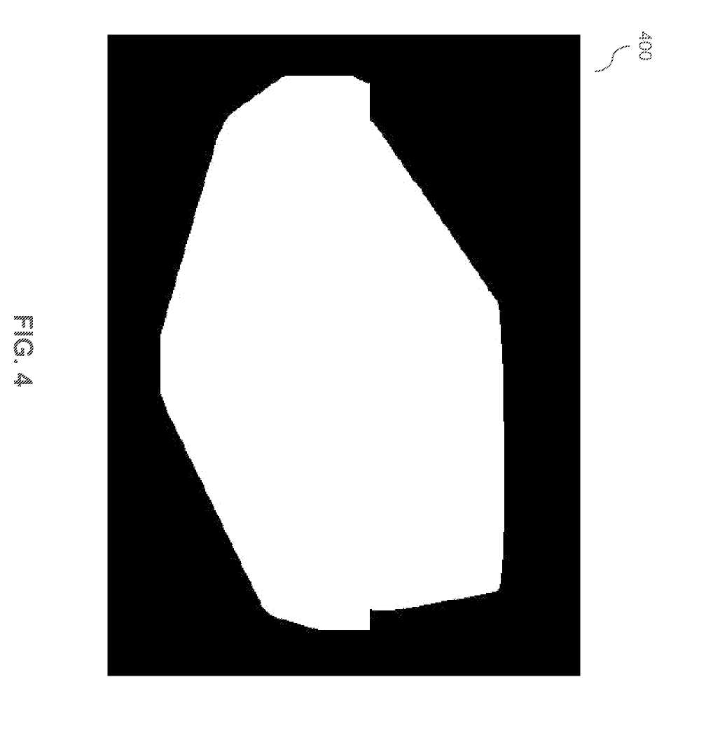

FIG. 4 depicts a dilated image segmentation mask 400, according to some embodiments. Dilated image segmentation mask 400 may be convex hull 300 that has been dilated. Dilation may be a process to increase the size of a region within an image. The size of the region may be increased by updating pixel values within the image to match pixel values of convex hull 300. As depicted, dilated image segmentation mask 400 is larger than convex hull 300. In some embodiments, only some regions (e.g., upper half, lower half, right side, left side) of convex hull 300 may be dilated. For example, dilated image segmentation mask 400 may be the result of dilating the lower half (e.g., lower region) of convex hull 300. In some embodiments, image processing system 110 may dilate a region of convex hull 300 based on where a shadow was detected within the image. For example, if the shadow is detected within the bottom of the image, then image processing system 110 may dilate the lower half of convex hull 300. Conversely, if the shadow is detected within the top of the image, then image processing system 110 may dilate the upper half of convex hull 300.

Image processing system 110 may generate dilated image segmentation mask 400 by determining a centroid of convex hull 300. The centroid may be a geographic center of convex hull 300. Image processing system 110 may use the centroid to divide convex hull 300 into regions. Image processing system 110 may identify the regions based on the location of the shadow in the image. For example, image processing system 110 may be configured to dilate a lower portion of convex hull 300 because the shadow is depicted in the lower portion of the image. As a result, image processing system 110 may then identify an upper half of convex hull 300 and a lower half of convex hull 300 by horizontally dividing convex hull 300 along the centroid. Similarly, image processing system 110 may be configured to dilate a left side of convex hull 300 based on determining the shadow is depicted in the left side of the image. Here, image processing system 110 may vertically divide convex hull 300 along the centroid into a left half and a right half.

Image processing system 110 may then apply a kernel filter to dilate the region of the image. For example, image processing system 110 may apply the kernel filter to the region corresponding to the lower half of convex hull 300. The kernel filter may be configured to update values of pixels of convex hull 300, to generate dilated image segmentation mask 400. The kernel filter may be an NxN matrix. In some embodiments, the kernel filter may be a matrix with a size of 50 pixels by 50 pixels. In some embodiments, the size of the kernel filter may be a function of the resolution of the image corresponding to image segmentation mask 200. For example, the higher the resolution of the image, the larger the kernel filter may be. Similarly, the size of the kernel filter may be a function of the size of the image. The larger the image, the larger the kernel filter that may be used to generate dilated image segmentation mask 400.

Image processing system 110 may be configured to slide the kernel filter over the region (e.g., the lower portion) of convex hull 300 and apply an update rule. In some embodiments, the update rule may dictate that if the kernel filter includes pixel values representing both the convex hull region (e.g., white pixels) and non-convex hull region (e.g., black pixels), then all pixel values covered by the kernel filter are updated to match the convex hull region (e.g., white pixels). As a result, the region of convex hull 300 is expanded by changing non-convex hull region pixels into convex hull region pixels. For example, black pixels are updated to be white pixels. In some embodiments, image processing system 110 may use different sized kernel filters. For example, when a smaller kernel filter is used, dilated image segmentation mask 400 may be smaller than when a larger kernel filter is used. In some embodiments, image processing system 110 may combine the dilated portion of the convex hull 300 with the un-dilated portion of the convex hull 300 to generate dilated image segmentation mask 400.

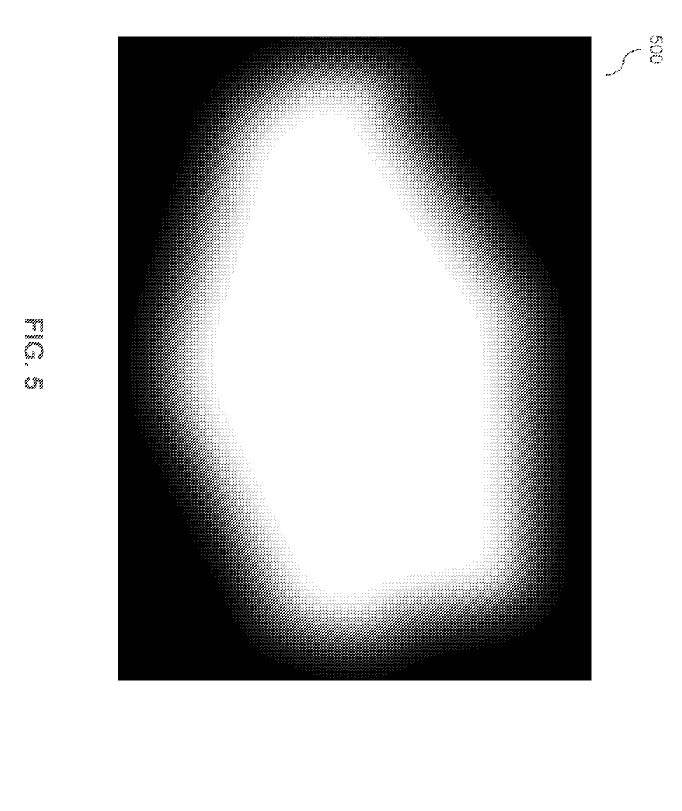

FIG. 5 depicts a blurred image segmentation mask 500, according to some embodiments. Image processing system 110 may generate blurred image segmentation mask 500 by applying a blur filter to dilated image segmentation mask 400. For example, image processing system 110 may use a Gaussian blur filter. Image processing system 110 may use any sigma value to generate Gaussian blue filter. In some embodiments, the sigma value may be a function of the resolution of the image or the size of the image. By applying the blur filter, the pixel values in blurred image segmentation mask 500 may have values in a range from 0 to 255 or 0 to 1, as opposed to having binary values (e.g., 0 or 255, 0 or 1).

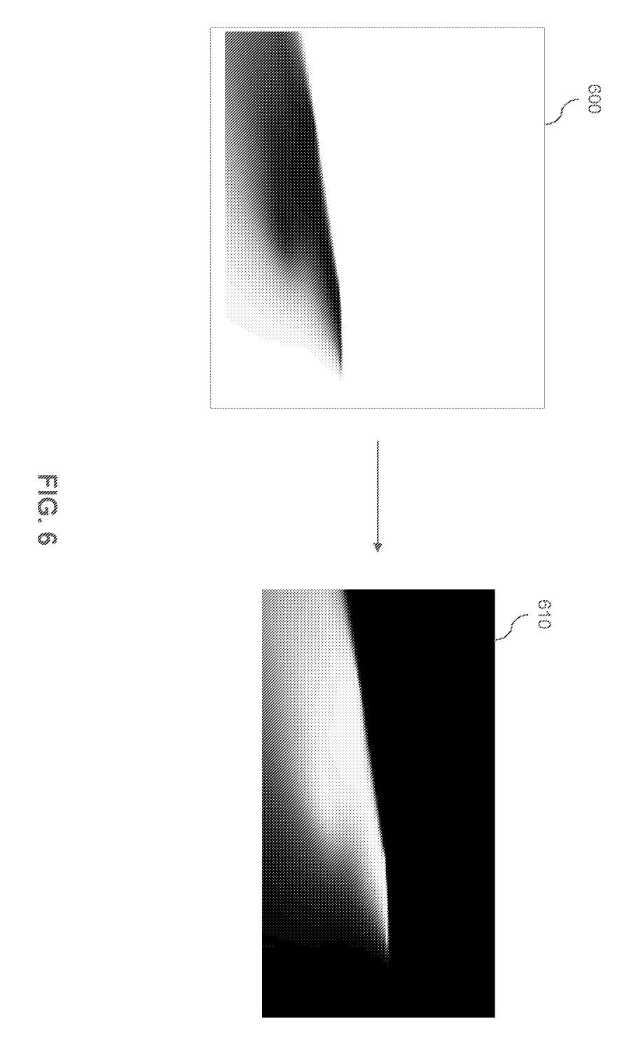

FIG. 6 depicts target region 600 of an image, according to some embodiments. Target region 600 may be a shadow within the image. In some embodiments, image processing system 110 may receive an identification of target region 600 (e.g., the shadow region) within the image. In some embodiments, image processing system 110 may identify target region 600 by applying a detection algorithm configured to identify a shadow within an image. Image processing system 110 may be configured to alter target region 600 to generate altered target region 610. Altered target region 610 may be generated by inverting pixel values of target region 600. For example, white pixels (e.g., 0) may be converted to black pixels (e.g., 255), and vice versa.

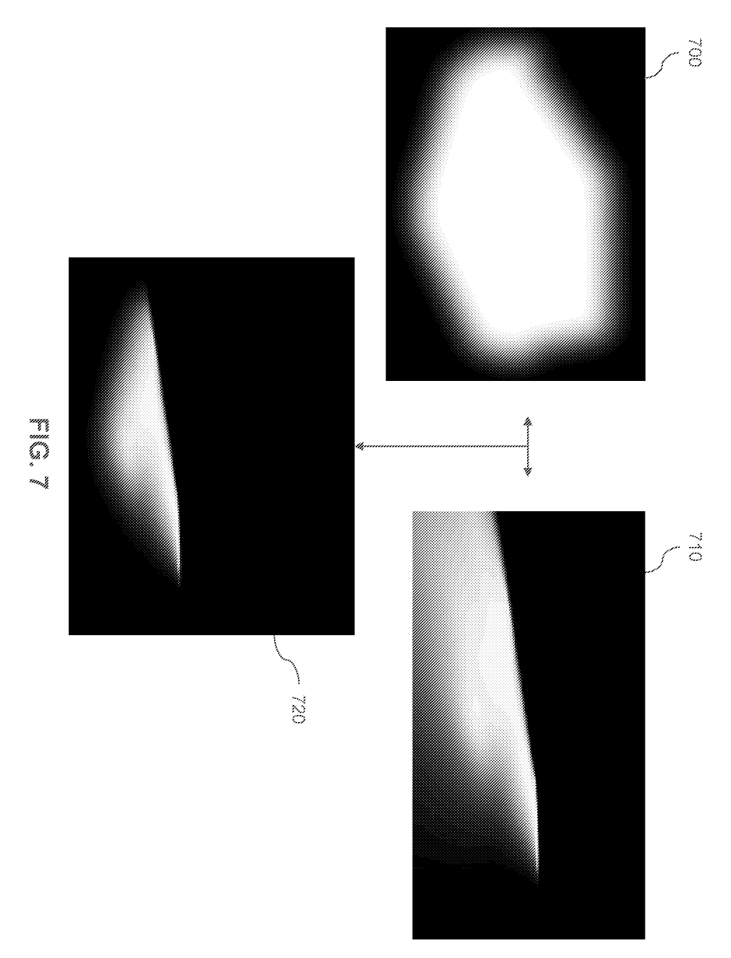

FIG. 7 depicts combining image segmentation mask 700 and target region 710 of an image, to produce updated target region 720, according to some embodiments. Image segmentation mask 700 may be blurred image segmentation mask 500 discussed above. Target region 710 may be altered target region 610 discussed above. Image processing system 110 may combine image segmentation mask 700 and target region 710 by multiplying pixel values at each position within image segmentation mask 700 and target region 710. For example, pixels at location (1, 1) of image segmentation mask 700 and target region 710 may be multiplied, pixels at location (1, 2) of image segmentation mask 700 and target region 710 may be multiplied, and so on. In some embodiments, image processing system 110 may normalize pixel values of image segmentation mask 700 and target region 710 such that the pixel values are between a range (e.g., 0 to 1), prior to generating updated target region 720.

Updated target region 720 may be the result of combining image segmentation mask 700 and target region 710. As depicted, updated target region 720 may depict a smaller version of target region 710 because some of the white pixels of target region 710 have been turned to black pixels as a result of being combined with image segmentation mask 700. As noted above, target region 710 may depict the shadow region of an image. By producing updated target region 720 and thereby reducing or suppressing the shadow region, the overall size of the image may be reduced. As a result, fewer computing and networking resources need to be utilized for hosting, displaying, and sending the image. Furthermore, the disparity in how third party images appear on a platform (e.g., social media site, e-commerce site) is reduced because the shadows are depicted is more uniform manner through shadow suppression.

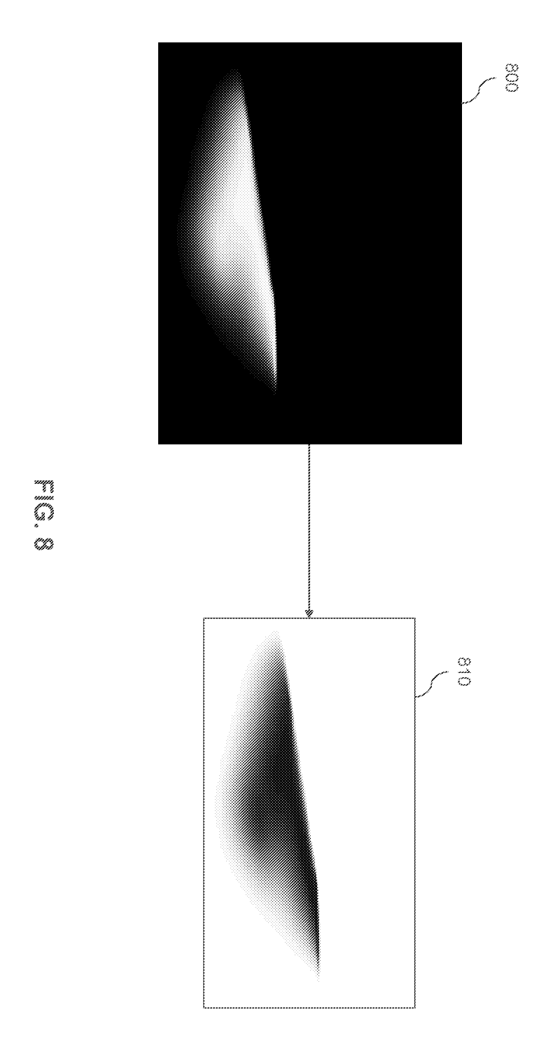

FIG. 8 depicts a target region 800 of an image, according to some embodiments. Target region 800 may be updated target region 720 depicting a suppressed shadow region of an image. As discussed above with regard to FIG. 6, pixel values of the target region depicting the shadow may be inverted to be combined with the image segmentation mask. Once target region 800 is generated, the pixel values may be inverted. As a result, updated target region 810 may depict target region 800 with inverted pixel values. Updated target region 810 may depict the final suppressed shadow for display. In some embodiments, image processing system 110 may add updated target region 810 to the original image depicting the object. In some embodiments, image processing system 110 may provide updated target region 810 to a third party such as target server 130 and/or client device 140.

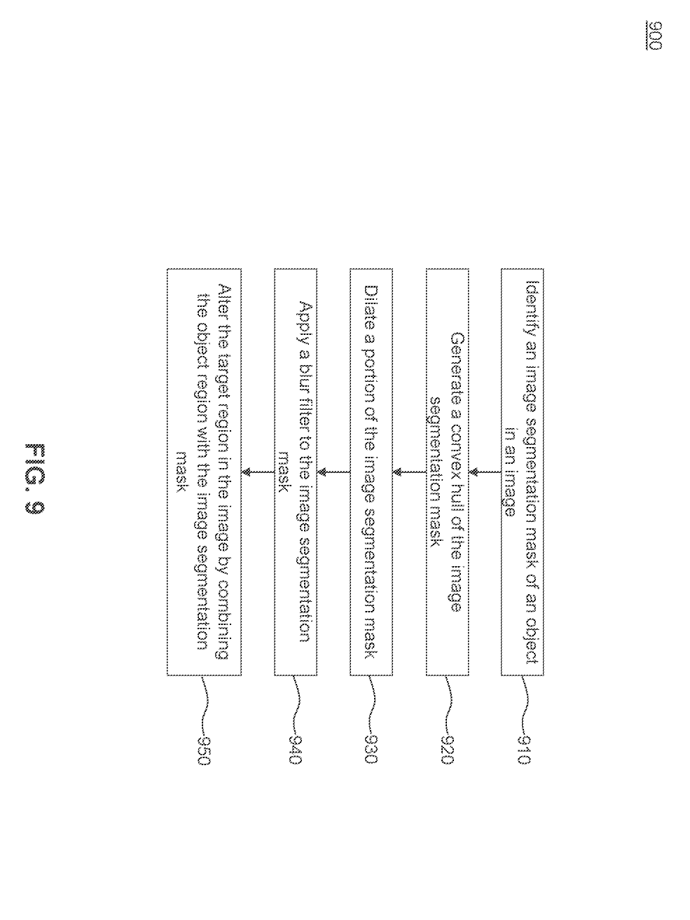

FIG. 9 depicts a flowchart illustrating a method 900 for suppressing a shadow in an image, according to some embodiments. Method 900 shall be described with reference to FIG. 1, however, method 900 is not limited to that example embodiment.

In an embodiment, imaging processing system 110 may utilize method 900 to automatically suppress a shadow region in an image. The foregoing description will describe an embodiment of the execution of method 900 with respect to imaging processing system 110. While method 900 is described with reference to imaging processing system 110, method 900 may be executed on any computing device, such as, for example, the computer system described with reference to FIG. 11 and/or processing logic that may comprise hardware (e.g., circuitry, dedicated logic, programmable logic, microcode, etc.), software (e.g., instructions executing on a processing device), or a combination thereof. For example, method 900 may be executed on target server 130 or client device 140.

It is to be appreciated that not all steps may be needed to perform the disclosure provided herein. Further, some of the steps may be performed simultaneously, or in a different order than shown in FIG. 9.

At 910, image processing system 110 identifies an image segmentation mask of an object in an image. The image segmentation mask may be image segmentation mask 200. In some embodiments, image processing system 110 may receive the image, such as from target server 130 or client device 140. The image may depict an object such as a vehicle. In some embodiments, image processing system 110 may identify the image segmentation mask by executing an object detection process to identify the region of the image depicting the object. The image segmentation mask may depict the object such that pixels of the image segmentation mask have a first color (e.g., white, 0) and the remainder of the pixels of the image have a second color (e.g., black, 255). In some embodiments, image processing system 110 may receive the image segmentation mask along with the image. For example, image processing system 110 may receive a separate image that is the image segmentation mask. In some embodiments image processing system 110 may receive pixel coordinates forming a polygon defining the image segmentation mask. In some embodiments, image processing system 110 may identify a region within the image. The region may depict a shadow of the object in the image. In some embodiments, image processing system 110 may receive identification of the region in the image from target server 130 and/or client device 140.

At 920, image processing system 110 generates a convex hull of the image segmentation mask. The convex hull may be convex hull 300. Image processing system 110 may generate the convex hull such that a line joining any two points on the object depicted in the image is completely within the region of the convex hull. Image processing system 110 may update the image segmentation mask to match the size of the convex hull. For example, image processing system 110 may generate a polygon defining the boundary of the convex hull. Image processing system 110 may then update each pixel value within the region of the polygon (e.g., the convex hull) to match the pixel value of the image segmentation mask.

At 930, image processing system 110 dilates a portion of the image segmentation mask. The dilated portion of the image segmentation mask may be dilated image segmentation mask 400. Dilating the portion of the image segmentation mask may increase the size of the image segmentation mask. Image processing system 110 may use a kernel filter (e.g., an NxN matrix) to dilate the image segmentation mask. The dimensions of the kernel filter may be a function of the size of the image or the resolution of the image. The portion of the image segmentation mask that is dilated may correspond to the region of the image depicting the shadow. For example, if the shadow is at the bottom of the image, image processing system 110 may dilate the bottom of the image segmentation mask. Image processing system 110 may reference the centroid (e.g., geographic center) of the image segmentation mask to divide the image segmentation mask into regions (e.g., top, bottom, left, right).

At 940, image processing system 110 applies a blur filter to the image segmentation mask. The blurred image segmentation mask may be blurred image segmentation mask 500. Image processing system 110 may use a Gaussian blur filter. In some embodiments, parameters of the Gaussian blur filter, such as the sigma value, may be a function of the image size, image resolution, or both. As a result of applying the blur filter, the pixel values of the image segmentation mask may be converted to grayscale (e.g., from 0 to 255).

At 950, image processing system 110 alters the target region in the image by combining the target region with the image segmentation mask. The image segmentation mask may be image segmentation mask 700 and the target region may be target region 710. As discussed above, image processing system 110 may alter the target region by multiplying the value of each pixel of the target region with the value of the pixel at the same position in the image segmentation mask. For example, image processing system 110 may multiply the pixel values in the target region and the image segmentation mask at positions (0, 0), (0, 1) … (N, N) etc. The resulting altered target region may be updated target region 720. In some embodiments, the updated target region may be a suppressed shadow to display within an image. For example, image processing system 110 may receive an image segmentation mask depicting a vehicle. Image processing system 110 may also receive an image of the vehicle including the vehicle’s shadow. Image processing system 110 may perform the steps above to generate the altered target region. The altered target region may be smaller than the shadow depicted in the image. In some embodiments, image processing system 110 may alter the original image to replace the original shadow with the suppressed shadow (e.g., the altered target region). In some embodiments, image processing system 110 may transmit the altered target region for inclusion in the original image. For example, image processing system 110 may transmit the altered target region to target server 130 and/or client device 140 for inclusion in the original image. As a result of suppressing the shadow, the overall image may be reduced in size, thereby consuming fewer computing and networking resources when displaying, sending, or otherwise interacting with the image.

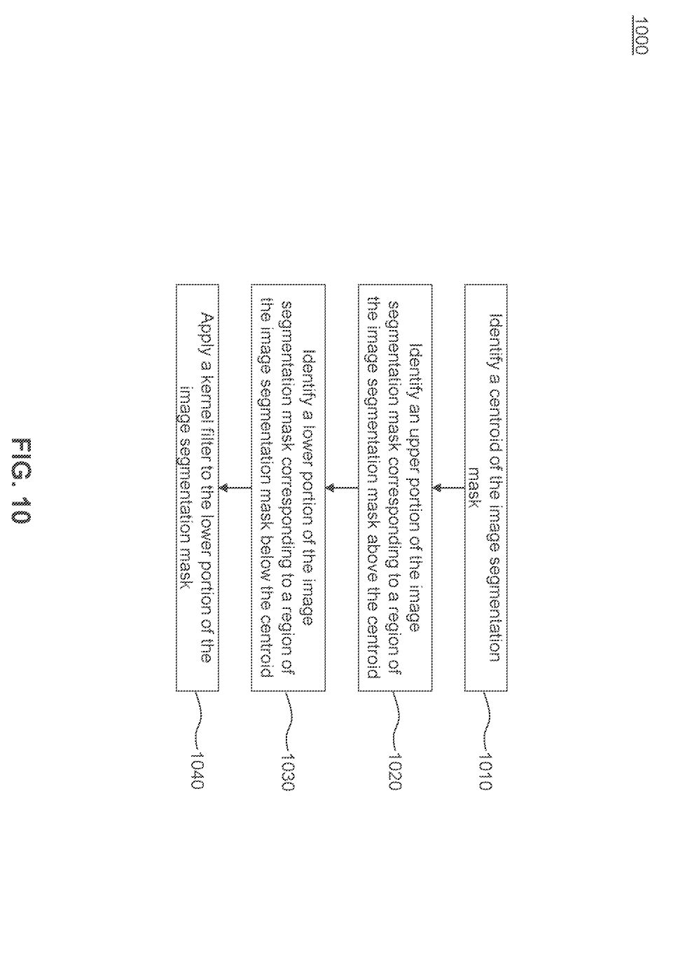

FIG. 10 depicts a flowchart illustrating a method 1000 for dilating an image, according to some embodiments. Method 1000 shall be described with reference to FIG. 1, however, method 1000 is not limited to that example embodiment.

In an embodiment, imaging processing system 110 may utilize method 1000 to dilate an image segmentation mask. Image processing system 110 may dilate the image segmentation mask to increase its size. In some embodiments, image processing system 110 may dilate a region of the image segmentation mask, such as the lower half of the image segmentation mask. The foregoing description will describe an embodiment of the execution of method 300 with respect to imaging processing system 110. While method 1000 is described with reference to imaging processing system 110, method 1000 may be executed on any computing device, such as, for example, the computer system described with reference to FIG. 12 and/or processing logic that may comprise hardware (e.g., circuitry, dedicated logic, programmable logic, microcode, etc.), software (e.g., instructions executing on a processing device), or a combination thereof. For example, method 1000 may be executed on target server 130 or client device 140.

It is to be appreciated that not all steps may be needed to perform the disclosure provided herein. Further, some of the steps may be performed simultaneously, or in a different order than shown in FIG. 10.

At 1010, image processing system 110 identifies a centroid of the image segmentation mask. The image segmentation mask may be convex hull 300, depicting the convex hull of an object. The centroid may be the geographic center of the image segmentation mask.

At 1020, image processing system 110 identifies an upper portion of the image segmentation mask corresponding to a region of the image segmentation mask above the centroid. The upper portion may include the pixels of the image segmentation mask above the centroid. Image processing system 110 may identify the upper portion based on the location of the shadow in the original image. For example, if the shadow is in the top or bottom of the image, image processing system 110 may identify the top portion of the image segmentation mask.

At 1030, image processing system 110 identifies a lower portion of the image segmentation mask corresponding to a region of the image segmentation mask below the centroid. The lower portion may include the pixels of the image segmentation mask below the centroid. Image processing system 110 may identify the upper portion based on the location of the shadow in the original image. For example, if the shadow is in the top or bottom of the image, image processing system 110 may identify the bottom portion of the image segmentation mask.

At 1040, image processing system 110 applies a kernel filter to the lower portion of the image segmentation mask. Image processing system 110 may apply the kernel filter to the lower portion of the image segmentation mask based on determining the shadow is depicted in a lower portion of the image. The kernel filter may be configured to update values of pixels of convex hull 300, to generate dilated image segmentation mask. The kernel filter may be an NxN matrix. In some embodiments, the size of the kernel filter may be a function of the image resolution, image size, or both. Image processing system 110 may be configured to slide the kernel filter over the lower portion of the image segmentation mask and apply an update rule. In some embodiments, the update rule may dictate that if the kernel filter includes pixel values representing both the image segmentation mask region (e.g., white pixels) and non-image segmentation mask region (e.g., black pixels), then all pixel values covered by the kernel filter are updated to match the image segmentation mask (e.g., white pixels). As a result, the region of the image segmentation mask is expanded.

Various embodiments may be implemented, for example, using one or more well-known computer systems, such as computer system 1100 shown in FIG. 11. One or more computer systems 1100 may be used, for example, to implement any of the embodiments discussed herein, as well as combinations and sub-combinations thereof.

Computer system 1100 may include one or more processors (also called central processing units, or CPUs), such as a processor 1104. Processor 1104 may be connected to a communication infrastructure or bus 1106.

Computer system 1100 may also include user input/output device(s) 1103, such as monitors, keyboards, pointing devices, etc., which may communicate with communication infrastructure 1106 through user input/output interface(s) 1102.

One or more of processors 1104 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 may also include a main or primary memory 1108, such as random access memory (RAM). Main memory 1108 may include one or more levels of cache. Main memory 1108 may have stored therein control logic (e.g., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 may include a computer usable or readable storage device having stored thereon computer software (control logic) and/or data. Removable storage unit 1118 may be a floppy disk, magnetic tape, compact disk, DVD, optical storage disk, and/ any other computer data storage device. Removable storage drive 1114 may read from and/or write to removable storage unit 1118.

Secondary memory 1110 may include other means, devices, components, instrumentalities or other approaches for allowing computer programs and/or other instructions and/or data to be accessed by computer system 1100. Such means, devices, components, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 may enable computer system 1100 to communicate and interact with any combination of external devices, external networks, external entities, etc. (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, the Internet, etc. Control logic and/or data may be transmitted to and from computer system 1100 via communication path 1126.

Computer system 1100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
generating a convex hull of an image segmentation mask within an image,
wherein the image segmentation mask depicts the shape of an object within the image, and
wherein the image comprises one or more pixels each having a corresponding value,
updating a size of the image segmentation mask to match a size of the convex hull;
dilating a portion of the image segmentation mask using a kernel, wherein the kernel is configured to increase a size of the portion of the image segmentation mask;
applying a blur filter to the image segmentation mask, wherein the blur filter is configured to update a value of a pixel of the image segmentation mask within a range from 0 to 255;
inverting a value of a pixel of a target region within the image;
altering the target region by multiplying the value of the pixel of the target region with the value of the pixel of the image segmentation mask; and
inverting the value of the pixel value of the target region within the image.

2. The method of claim 1, wherein the object is a vehicle and wherein the target region depicts a shadow.

3. The method of claim 1, wherein updating the image segmentation mask to match a size of the convex hull comprises updating a value of the one or more pixels of the image to equal the value of the pixel of the image segmentation mask.

4. The method of claim 1, wherein prior to altering the target region, the method further comprises normalizing the value of the pixel of the image segmentation mask between 0 and 1.

5. The method of claim 1, wherein dilating the portion of the segmentation mask comprises:
identifying a centroid of the image segmentation mask;
identifying an upper portion of the image segmentation mask corresponding to a region of the image segmentation mask above the centroid; and
identifying a lower portion of the image segmentation mask corresponding to a region of the image segmentation mask below the centroid, wherein the portion is the lower portion.

6. The method of claim 1, wherein the blur filter is a Gaussian blur filter and wherein a sigma value of the Gaussian blur filter is determined based on a resolution of the image.

7. The method of claim 1, wherein a dimension of the kernel is determined based on a resolution of the image.

8. A system, comprising:
a memory; and
at least one processor coupled to the memory and configured to:
generate a convex hull of an image segmentation mask within an image,
wherein the image segmentation mask depicts the shape of an object within the image, and
wherein the image comprises one or more pixels each having a corresponding value,
update a size of the image segmentation mask to match a size of the convex hull;
dilate a portion of the image segmentation mask using a kernel, wherein the kernel is configured to increase a size of the portion of the image segmentation mask;
apply a blur filter to the image segmentation mask, wherein the blur filter is configured to update a value of a pixel of the image segmentation mask within a range from 0 to 255;
invert a value of a pixel of a target region within the image;
alter the target region by multiplying the value of the pixel of the target region with the value of the pixel of the image segmentation mask; and
invert the value of the pixel value of the target region within the image.

9. The system of claim 8, wherein the object is a vehicle and wherein the target region depicts a shadow.

10. The system of claim 8, wherein to update the image segmentation mask to match a size of the convex hull, the at least one processor is further configured to update a value of the one or more pixels of the image to equal the value of the pixel of the image segmentation mask.

11. The system of claim 8, wherein prior to altering the target region, the at least one processor is further configured normalize the value of the pixel of the image segmentation mask between 0 and 1.

12. The system of claim 8, wherein to dilate the portion of the segmentation mask, the at least one processor is further configured:
identify a centroid of the image segmentation mask;
identify an upper portion of the image segmentation mask corresponding to a region of the image segmentation mask above the centroid; and
identify a lower portion of the image segmentation mask corresponding to a region of the image segmentation mask below the centroid, wherein the portion is the lower portion.

13. The system of claim 8, wherein the blur filter is a Gaussian blur filter and wherein a sigma value of the Gaussian blur filter is determined based on a resolution of the image.

14. The system of claim 8, wherein a dimension of the kernel is determined based on a resolution of the image.

15. A non-transitory computer-readable device having instructions stored thereon that, when executed by at least one computing device, cause the at least one computing device to perform operations comprising:
generating a convex hull of an image segmentation mask within an image,
wherein the image segmentation mask depicts the shape of an object within the image, and
wherein the image comprises one or more pixels each having a corresponding value,
updating a size of the image segmentation mask to match a size of the convex hull;
dilating a portion of the image segmentation mask using a kernel, wherein the kernel is configured to increase a size of the portion of the image segmentation mask;
applying a blur filter to the image segmentation mask, wherein the blur filter is configured to update a value of a pixel of the image segmentation mask within a range from 0 to 255;
inverting a value of a pixel of a target region within the image;
altering the target region by multiplying the value of the pixel of the target region with the value of the pixel of the image segmentation mask; and
inverting the value of the pixel value of the target region within the image.

16. The non-transitory computer-readable device of claim 15, wherein the object is a vehicle and wherein the target region depicts a shadow.

17. The non-transitory computer-readable device of claim 15, wherein to update the image segmentation mask to match a size of the convex hull, the operations further comprise updating a value of the one or more pixels of the image to equal the value of the pixel of the image segmentation mask.

18. The non-transitory computer-readable device of claim 15, wherein prior to altering the target region, the operations further comprise normalizing the value of the pixel of the image segmentation mask between 0 and 1.

19. The non-transitory computer-readable device of claim 15, wherein to dilate the portion of the segmentation mask the operations comprise:
identifying a centroid of the image segmentation mask;
identifying an upper portion of the image segmentation mask corresponding to a region of the image segmentation mask above the centroid; and
identifying a lower portion of the image segmentation mask corresponding to a region of the image segmentation mask below the centroid, wherein the portion is the lower portion.

20. The non-transitory computer-readable device of claim 15, wherein the blur filter is a Gaussian blur filter and wherein a sigma value of the Gaussian blur filter is determined based on a resolution of the image.
